(19) United States
(12) Patent Application Publication
(10) Pub. No.: US 2025/0382192 A1
(43) Pub. Date: Dec. 18, 2025

(54) METHOD FOR TREATING SALT-CONTAINING DUSTS

(71) Applicant: AMATEQ HOLDING GMBH, Münster (DE)

(72) Inventors: Alexander KEHRMANN, Münster (DE); Detlef EDELKOTT, Ehingen (DE)

(21) Appl. No.: 18/877,043

(22) PCT Filed: Jun. 13, 2023
(86) PCT No.: PCT/EP2023/065729

§ 371 Date: Dec. 19, 2024

(30) Foreign Application Priority Data
Jun. 20, 2022 (EP) 22179873.9

(51) Int. Cl. C01D 3/08; B01D 9/00; B01D 21/26; C02F 1/463; C02F 1/52; C02F 101/10; C02F 101/20

(52) U.S. Cl. CPC C01D 3/08; B01D 9/0018; B01D 9/004; B01D 21/262; C02F 1/463; C02F 1/52; C02F 2101/101; C02F 2101/20

(57) ABSTRACT

The present invention relates to a method for treating salt-containing dusts which accumulate during operation of industrial plants, e.g. in waste incineration plants, or during operation of rotary kilns, e.g. in cement production plants or clinker production plants. The method comprises a step a) of forming an aqueous solution by bringing salt-containing dusts into contact with an aqueous phase; a step b) of removing heavy metals from the aqueous solution; and a step c) of separating alkali metal chlorides from the aqueous solution; and the bringing of salt-containing dusts into contact with an aqueous phase in step a) is achieved by means of a multi-stage arrangement through which the salt-containing dusts and the aqueous phase pass in opposite directions.

### TECHNICAL FIELD

The present invention relates to a method for treating salt-containing dusts which accumulate during operation of industrial plants, e.g. in waste incineration plants, or during operation of rotary kilns, e.g. in cement production plants or clinker production plants.

### BACKGROUND

During operation of industrial plants, large amounts of salt-containing dusts often accumulate, the utilization of which is attracting ever more attention in view of the foreseeable shortage of raw materials and increasing sustainability efforts. Even if disposal of these substances is considered, the composition thereof can have a significant influence on the associated costs.

### Object and Aims of the Invention

Against the stated background, it was an objective of the inventors to develop a method by means of which raw materials can be recovered from salt-containing dusts. This method is intended to return as large a quantity of material as possible to the economic cycle. At the same time, the recovered material is intended to be enhanced by the method, in that it can be provided in as pure a form as possible.

### DESCRIPTION OF THE FIGURES

FIG. 1 schematically shows a three-stage configuration of the multi-stage arrangement which is used for bringing the salt-containing dusts into contact with an aqueous phase in step a) of the method according to the invention. The embodiment comprises three mixing apparatus and three separating devices. The salt-containing dusts are fed to the mixing apparatus of the first stage, and the aqueous phase is fed to the mixing apparatus of the third stage. The solid outflow of the separating device of the third stage constitutes the treated dusts, and the aqueous outflow of the separating device of the first stage is fed to step b) of the method.

FIG. 2 shows an illustration, by way of example, of the method according to the invention:

“washing process”—step a)
“purification of the brine”—step b)
“salt crystallization & drying”—step c)

### SUMMARY OF THE INVENTION

The stated objects are achieved by the method of the invention according to (1) to (26):
1. Method for treating salt-containing dusts, wherein the method comprises the following steps:
   a) forming an aqueous solution by bringing salt-containing dusts into contact with an aqueous phase;
   b) removing heavy metals from the aqueous solution; and
   c) separating alkali metal chlorides from the aqueous solution, and the bringing of salt-containing dusts into contact with an aqueous phase in step a) is achieved by means of a multi-stage arrangement through which the salt-containing dusts and the aqueous phase pass in opposite directions.
2. Method according to point 1, wherein for step a) a multi-stage countercurrent cascade is used, which comprises a mixing apparatus in each stage as well as a separating device fed by the outflow from the mixing apparatus.
3. Method according to point 2, wherein belt filters, centrifuges or filter presses are used as the separating device.
4. Method according to point 3, wherein for step a) a multi-stage countercurrent cascade of centrifuges, preferably decanter centrifuges, is used, and wherein
the salt-containing dusts and the aqueous outflow of the centrifuge belonging to the last stage are fed to the mixing apparatus belonging to the first stage,
the mixing apparatus belonging to the last stage is fed with water as the aqueous phase,
with the exception of the last stage, the solid outflow of a centrifuge is in each case fed to the mixing apparatus belonging to the next stage,
with the exception of the first stage, the aqueous outflow of a centrifuge is in each case fed to the mixing apparatus belonging to the preceding stage, and
the aqueous outflow of the centrifuge belonging to the first stage serves as the starting material for step b).
5. Method according to any one of points 2 to 4, wherein the mixing apparatus is a stirred tank.
6. Method according to any one of points 2 to 5, wherein the multi-stage arrangement in step a) comprises 2 to 5 stages, preferably 3 or 4 stages.
7. Method according to any one of points 2 to 6, wherein the ratio of the volume of aqueous phase used to the mass of salt-containing dust used in step a) is in the range of 0.8 l/kg to 2 l/kg, preferably of 1.0 l/kg to 1.5 l/kg, and particularly preferred of 1.2 l/kg to 1.4 l/kg.
8. Method according to any one of points 1 to 7, in which the heavy metals are removed from the aqueous solution in step b) by extraction or precipitation.
9. Method according to point 8, wherein electrocoagulation is used for precipitating the heavy metals.
10. Method according to point 9, wherein the apparatus for electrocoagulation comprises an Fe and/or Al electrode.
11. Method according to either point 9 or point 10, wherein flocculate that is formed is separated by means of filtration or by centrifugation.
12. Method according to any one of points 1 to 11, wherein the alkali metal chlorides are separated in step c) by fractional crystallization.
13. Method according to any one of points 1 to 12, in which the alkali metal chlorides are at least one selected from the group comprising sodium chloride (NaCl) and potassium chloride (KCl).
14. Method according to either point 12 or point 13, in which during and/or after step c) the crystalline alkali metal chlorides are mechanically separated.
15. Method according to any one of points 12 to 14, in which the separated crystalline alkali metal chlorides are dried.
16. Method according to point 15, in which the dried crystalline alkali metal chlorides are ground.
17. Method according to any one of points 1 to 16, in which the aqueous phase contains at least one auxiliary substance which is selected from inorganic substances, preferably ammonium polysulfide and chlorides, nitrates, sulfides and sulfates of the alkali and alkaline earth metals, and organic substances, preferably salts of chelating acids such as EDTA.
18. Method according to any one of points 12 to 17, in which the fractional crystallization includes the evaporation of the aqueous solution.
19. Method according to point 18, in which the aqueous solution is evaporated, in the fractional crystallization, to approximately 70% of the volume before step c), preferably to approximately 50% of the volume before step c), particularly preferred to approximately 30% of the volume before step c).
20. Method according to any one of points 1 to 19, in which the heavy metals are at least one selected from the group comprising As, Be, Cd, Co, Cr, Cu, Hg, Mn, Ni, Pb, Sb, Sn, Te, Tl and V.
21. Method according to any one of points 4 to 20, wherein the water fed in the last stage is fresh water, saltwater, or process water.
22. Method according to any one of points 18 to 21, wherein the evaporated water is returned to the method at least in part, and is preferably fed to the last stage of the multi-stage arrangement.
23. Method according to any one of points 4 to 22, wherein part of the aqueous outflow of a centrifuge is returned to the mixing apparatus belonging to the same stage.
24. Method according to any one of points 1 to 23, wherein in the first stage of the multi-stage arrangement an additive is added for precipitating sulfate ions.
25. Method according to point 24, wherein calcium chloride or hydrogen chloride is used as the additive.
26. Method according to point 25, wherein the hydrogen chloride is used in gaseous form or in the form of an aqueous hydrochloric acid solution.

The method allows for efficient removal and recovery of salts, in particular sodium chloride (NaCl) and potassium chloride (KCl), from salt-containing dusts. At the same time, the heavy metal content of the dusts is reduced, as a result of which new possible uses for the dusts can be developed. Thus, the method makes it possible to develop a plurality of marketable recyclable materials from materials which would otherwise have to be laboriously disposed of.

### DESCRIPTION OF THE INVENTION

The method according to the invention for treating salt-containing dusts comprises a plurality of steps. In step a) an aqueous solution is formed by bringing salt-containing dusts into contact with an aqueous phase. The bringing of salt-containing dusts into contact with an aqueous phase is achieved by means of a multi-stage arrangement through which the salt-containing dusts and the aqueous phase pass in opposite directions.

In step b) heavy metals are removed from the aqueous solution. And in step c) alkali metal chlorides are separated from the aqueous solution.

The method according to the invention for treating salt-containing dusts is, in principle, suitable for use in all plants and situations in which dusts containing water-soluble salts accumulate, e.g. in waste incineration plants or during operation of rotary kilns.

For reasons of energy efficiency, however, it is preferred to use the method according to the invention in industrial plants in which the exhaust gas and/or waste streams are carrying excess heat, e.g. plants for cement production, brick production, or clinker production.

### Step a)

In the method according to the invention, the salt-containing dusts are brought into contact, in step a), with an aqueous phase. This takes place by means of a multi-stage arrangement through which the salt-containing dusts and the aqueous phase pass in opposite directions.

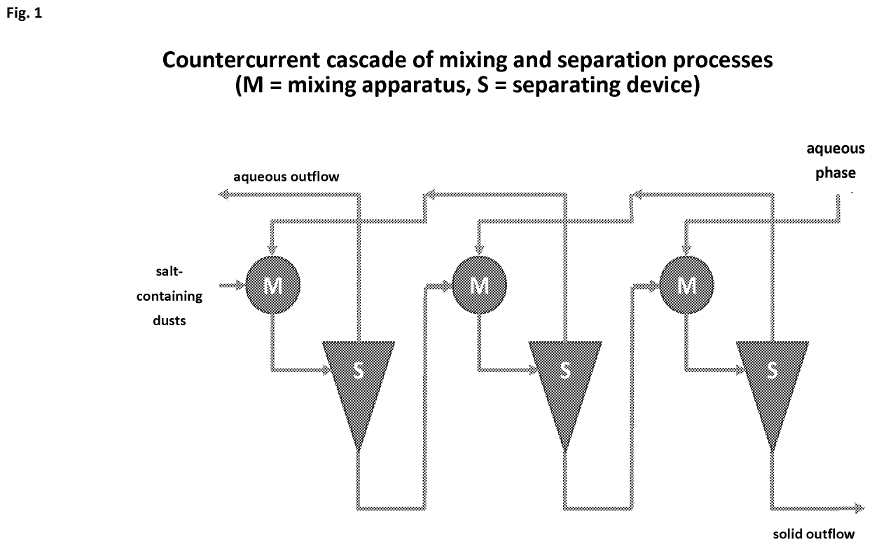

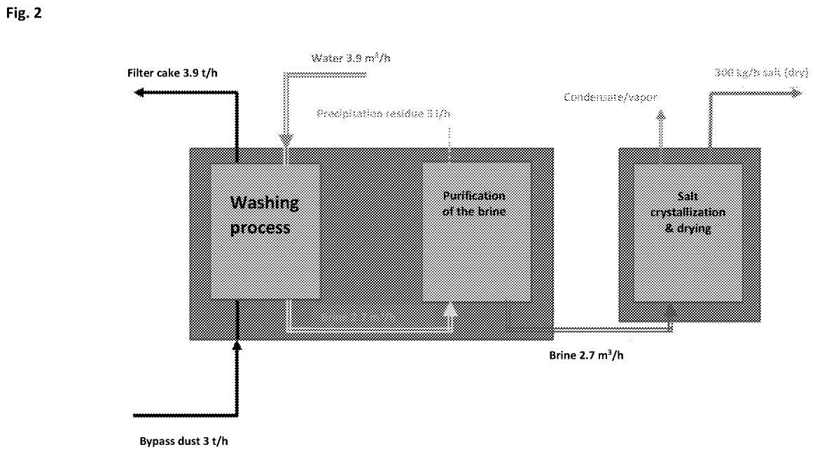

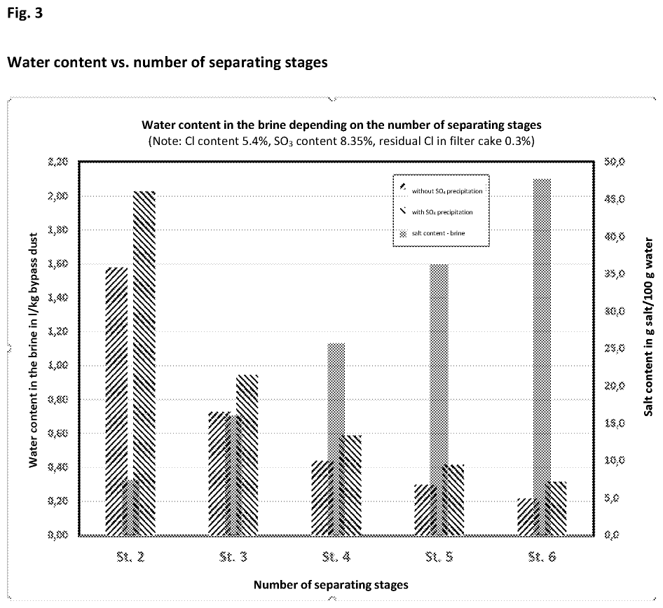

This can be achieved e.g. in that a mixing apparatus for mixing a solid and an aqueous phase, and a separating device fed by the outflow of the mixing apparatus and intended for separating into a solid and an aqueous phase are used in each stage of the multi-stage arrangement (see FIG. 1).

The mixing apparatus may, for example, be a stirred tank.

The separating device may, for example, be a belt filter, a centrifuge, or a filter press. In this case, preferably centrifuges and particularly preferred decanter centrifuges are used. The use of centrifuges offers the advantage, compared with the use of filters, that a possible caking of material on the filter and other parts of the plant on account of precipitation and splashes does not occur. As a result, the maintenance interval of the plant increases.

The aqueous phase used in step a) may, for example, be fresh water, saltwater, or process water. It may in particular be demineralized water, tap water, drinking water or process water (i.e. water that is not of drinking water quality). In this case, the use of process water is economically advantageous. In order to reduce the water consumption of the method, water vapor accumulating in step c) can be collected by means of an extraction device, condensed, and used as the aqueous phase. If water-soluble components of the aqueous solution are separated in part or completely in step c) by means of fractional crystallization, the mother liquor obtained in the process can also be used as the aqueous phase. In the case of such an approach, it is preferred for the temperature during the fractional crystallization to be lower than the temperature during step a), such that an efficient dissolution of water-soluble components in the aqueous phase can be ensured.

Furthermore, the aqueous phase may contain one or more auxiliary substances in order to promote the treatment of the salt-containing dusts and in order to enhance the purification effect or the uptake of volatile components. In this connection, it is e.g. possible to add one or more auxiliary substances to the aqueous phase, which substances are selected from inorganic substances (preferably chlorides, nitrates, sulfides and sulfates of the alkali and alkaline earth metals as well as ammonium polysulfide) and organic substances (preferably salts of chelating acids such as Na₂-EDTA). In this case, the organic and inorganic substances also include acids, such as mineral acids (e.g. HCl, H₂SO₄, H₃PO₄, etc.) and/or organic acids (e.g. formic acid, acetic acid), and bases, such as inorganic bases (e.g. NaOH, KOH, LiOH, Ca(OH)₂) and/or organic bases (e.g. nitrogen-containing organic base, e.g. triethylamine and pyridine).

For example, calcium chloride or hydrogen chloride (in gaseous form or in the form of an aqueous hydrochloric acid solution) can be added to the aqueous phase as an additive for precipitation of sulfate ions. As a result, the purity of potassium chloride obtained in step c) can be increased.

The addition of organic salts or acids to the aqueous phase can have a solubility-improving effect on metals since these are then complexed in solution and are thus removed from the salt-containing dusts. This is favorable for reducing the heavy metal load, both for the case where the treated dusts are disposed of, and also for the case where they are reused. In the latter case, the load of the end product with metals can be reduced.

If organic or inorganic auxiliary substances are added to the aqueous phase, the concentration of said organic and/or inorganic substances in the aqueous phase is preferably 0.01 to 10 wt. %, more preferably 0.1 to 5 wt. %, and most preferably 0.5 to 3 wt. %. For process execution that is as economical as possible, the use of water (tap water or process water) as the aqueous phase is preferred, whereas the use of an aqueous phase containing one or more of the above-mentioned auxiliary substances may be preferred, for the above-mentioned reasons, for improved extraction of soluble substances or for removing undesired matter. The auxiliary substances can be added to the aqueous phase before this is brought into contact with the salt-containing dusts or can be metered into one of the stages of the multi-stage arrangement.

Corresponding auxiliary substances may, for example, be inorganic substances, in particular salts such as chlorides, nitrates, sulfides or sulfates of the alkali and alkaline earth metals, or also ammonium polysulfide. The aqueous phase may also contain organic substances, for example chelating acids such as EDTA. The latter increase the solubility of the heavy metal ions in the aqueous solution and thus promote the removal thereof from the salt-containing dusts.

In a preferred embodiment of the method, a multi-stage countercurrent cascade of centrifuges, preferably decanter centrifuges, is used for step a), wherein
the salt-containing dusts and the aqueous outflow of the centrifuge belonging to the last stage are fed to the mixing apparatus belonging to the first stage,
the mixing apparatus belonging to the last stage is fed with water as the aqueous phase,
with the exception of the last stage, the solid outflow of a centrifuge is in each case fed to the mixing apparatus belonging to the next stage,
with the exception of the first stage, the aqueous outflow of a centrifuge is in each case fed to the mixing apparatus belonging to the preceding stage, and
the aqueous outflow of the centrifuge belonging to the first stage serves as the starting material for step b).

The aqueous solution obtained in step a) contains the soluble components of the salt-containing dusts in dissolved form, and is fed to step b), described below, for further processing.

The water-insoluble components form the solid outflow of the multi-stage arrangement. These treated, low-salt dusts can be passed on for further utilization. For example, they can be returned to the production process that originally generated the salt-containing dust to be treated.

From the perspective of minimizing the required amount of water while at the same time maximizing the amount of salts that are removed from the salt-containing dusts, the multi-stage arrangement used in step a) preferably comprises 2 to 5 stages, particularly preferred 3 or 4 stages. Furthermore, for this purpose, part of the aqueous phase separated in one stage can be fed to the inlet of the same stage; e.g. part of the aqueous outflow of a centrifuge can be returned to the mixing apparatus belonging to the same stage. The more stages are used, the less water is required for a given washing performance.

Furthermore, from the perspective of minimizing the required amount of water while simultaneously maximizing the amount of salts, the ratio of the volume of aqueous phase used to the mass of salt-containing dust used in step a) is in the range of 0.8 l/kg to 2 l/kg, preferably of 1.0 l/kg to 1.5 l/kg, and particularly preferred of 1.2 l/kg to 1.4 l/kg.

The use of a larger amount of aqueous phase relative to the mass of salt-containing dust used makes it possible to dissolve more salt, but, as a result, the amount of water that has to be evaporated in step c) possibly also increases.

In the present application, the term “water-soluble components” relates to inorganic or organic substances which are dissolved in step a) in the aqueous phase and therefore become components of the aqueous solution. In contrast, the “water-insoluble components” are amorphous or crystalline solids which do not dissolve when step a) is carried out and can be separated from the aqueous solution by filtration or centrifugation. Water-soluble components and water-insoluble components may, for example, be components of the salt-containing dusts. However, the water-soluble components and the water-insoluble components may also contain chemical reaction products of the salt-containing dusts with the aqueous phase.

Since the salt-containing dusts are brought into contact with the aqueous phase, the water-soluble components dissolve in the aqueous phase. The water-insoluble components are preferably separated out, e.g. by filtration or by centrifugation. The water-insoluble components separated in this case (e.g. the filter cake obtained) have a significantly reduced concentration of alkali and alkaline earth metals (chlorides, sulfates, etc.) as well as of heavy metals (e.g. As, Be, Cd, Co, Cr, Cu, Hg, Mn, Ni, Pb, Sb, Sn, Te, TI, V). Thus, if desired, the separated water-insoluble components (e.g. the filter cake in the case of filtration) can optionally be returned to the method carried out in the industrial plant, which originally generated the salt-containing dust to be treated, e.g. a cement or clinker production process, without this leading to enrichment of the product of the industrial plant with these undesired substances. The separated water-insoluble components can also undergo intensive purification, e.g. by extraction, in order to further reduce the content of undesired components. On a small scale, such extraction can be performed e.g. by Soxhlet extraction. On an industrial scale, such extraction can be performed e.g. using a mixer-settler.

The water-soluble components which dissolve in the aqueous phase in step a) are composed substantially of chlorides and other volatile components, such as sulfates (or SO₃), but may also contain other components, such as heavy metals or nitrates.

The water-insoluble components, i.e. the treated dusts, have a substantially reduced chloride content.

Depending on the ratio of the volume of aqueous phase used to the mass of salt-containing dust used, the chloride content of the water-insoluble components can be reduced, after bringing into contact with the aqueous phase in step a) and the separation thereof, to less than 20 wt. %, preferably less than 10 wt. %, more preferably less than 5 wt. %, and most preferably less than 2 wt. % of the chloride content of the dusts before introduction through the aqueous phase (wt. %), i.e. of the chloride content of the starting materials. In view of this, the treated, low-salt dust is suitable, when returned into an industrial process, for reducing the chloride content of the process streams.

The multi-stage solid-liquid separation described above offers the advantage that it achieves a high washing performance with a low water usage.

### Step b)

In the method according to the invention, heavy metals are removed in step b) from the aqueous solution obtained in step a). Performing this step before recovering alkali and alkaline earth metal salts that are contained in the salt-containing dusts and are dissolved in the aqueous phase upon bringing into contact with the salt-containing dusts makes it possible to keep the content of heavy metals or the salts thereof as low as possible in the products obtained after step c).

Heavy metals may, for example, be precipitated by adding sulfides, polysulfides or other anions of difficult-to-dissolve heavy metal salts to the aqueous solution obtained in step a). It is thus possible to separate metals such as As, Be, Br, Cd, Cr, Hg, Ni, Pb, TI, V and Zn as difficult-to-dissolve salts (e.g. as sulfides). The mentioned anions are preferably introduced into the aqueous solution in the form of sodium compounds, e.g. Na₂S. A further preferred variant of the invention is the introduction of gaseous H₂S into the aqueous solution.

The precipitated heavy metal salts can be separated from the aqueous solution by methods which are known to a person skilled in the art, e.g. by filtration or centrifugation, and then dried.

Furthermore, the heavy metals can be separated from the aqueous solution and recovered by means of suitable ion-exchange resins. The ion-exchange resins suitable for this are known to a person skilled in the art and include, inter alia, resins having carboxyl groups or sulfonic acid groups. Corresponding ion-exchange resins are commercially available, for example, under the trade names Lewatit® (Lanxess), Dowex® (Dow Chemicals) and Amberlite® (Rohm and Haas).

However, a method by means of electrocoagulation has proven the most effective for precipitating the heavy metals.

The electrocoagulation method is known to a person skilled in the art and is described e.g. in WO 2016/189374 A1. In this case, an electrode pair is introduced into the solution and by applying a voltage the oxidative decomposition of the anode. The cations emerging from the anode undergo a redox reaction with dissolved heavy metal ions, which leads to the formation of a flocculate that contains the heavy metals.

After the flocculation of the heavy metals, these can be separated from the aqueous solution using methods which are known to a person skilled in the art, e.g. by filtration or centrifugation, and then dried.

On account of its high salt content, the aqueous solution obtained in step a) has a high electrical conductivity, and therefore the electrocoagulation method is particularly suitable for removing the heavy metal ions therefrom.

Preferably, an iron and/or an aluminum electrode is used for the electrocoagulation.

If the salt-containing dusts contain notable amounts of mercury, this can also already be separated before step a) by heating the dusts to convert the mercury into the gaseous state, and the gaseous mercury is then bound by means of a sulfide, e.g. sodium sulfide. A method of this kind is known to a person skilled in the art and also allows the (selective) separation of other highly volatile heavy metals.

### Step c)

In the method according to the invention, alkali metal chlorides are separated from the aqueous solution in step c).

The separation preferably takes place by means of fractional crystallization. In this case, the aqueous solution is evaporated to approximately 70% of the volume before step c), preferably to approximately 50% of the volume before step c), particularly preferred to approximately 30% of the volume before step c). The concentrated aqueous solution thus obtained can subsequently be cooled, such that a fractional crystallization of the alkali metal chlorides results. The alkali metal chlorides crystallize in succession, such that they have a particularly high degree of purity and can thus be used in a more commercially valuable and more versatile manner. The crystallized alkali metal chlorides can be separated from the aqueous solution by methods which are known to a person skilled in the art, e.g. by filtration, and then dried.

The method according to the invention thus makes it possible to obtain highly pure alkali metal chlorides from salt-containing dusts that accumulate e.g. during operation of rotary kilns, in particular in cement, clinker and brick production processes.

The alkali metal chlorides obtained according to the method of the invention are primarily sodium chloride and potassium chloride. On account of the fact that they have been obtained by fractional crystallization, they have a high degree of purity and can thus be supplied for various uses. Such uses include the use as road salt, salt licks, fertilizer, raw material for electrolysis for obtaining chlorine and/or alkali hydroxide, flame retardants, dust binders, as fertilizer components, or for glass or ceramics production.

Water vapor accumulating in step c) can be collected by means of an extraction device, condensed, and used as the aqueous phase in step a). This also applies for the aqueous phase remaining after crystallization of the alkali metal chlorides.

Unless otherwise specified, all the percentage values in the present application refer to percent by weight.

### EXAMPLES

### Example 1

The following table shows the analysis results of a dust before (“bypass dust”) and after (“filter cake”) passing through the method according to the invention. As is clear from the data, the treated dust has a noticeably reduced salt content.

TABLE 1
Salt content before and after treatment

| Mat. | | Bypass dust | Filter cake |
|---|---|---|---|
| Date | | 22 to 23 May 2021 | 22 to 25 May 2021 |
| Time | | 02:00 to 02:00 | 15:30 to 15:00 |
| Type | | Average | Average |
| Sample no. | | 563351 | 563350 |
| CO₂ (950° C.) | % | 3.38 | 6.22 |
| Water 950° C. | % | 2.25 | 18.73 |
| Chloride | % | 4.63 | 0.132 |
| Ignition loss | % | 5.63 | 24.95 |
| SiO₂ | gvh % | 13.51 | 12.36 |
| Al₂O₃ | gvh % | 3.19 | 2.93 |
| TiO₂ | gvh % | 0.14 | 0.13 |
| P₂O₅ | gvh % | 0.07 | 0.05 |
| Fe₂O₃ | gvh % | 1.54 | 1.48 |
| Manganese oxide | gvh % | 0.02 | 0.02 |
| MgO | gvh % | 0.95 | 1.01 |
| CaO | gvh % | 48.15 | 46.51 |
| SO₃ | gvh % | 8.35 | 8.07 |
| K₂O | gvh % | 6.92 | 1.15 |
| Na₂O | gvh % | 0.44 | 0.15 |
| Na₂O-eqiv. | gvh % | 4.99 | 0.91 |

### Example 2

The graph of FIG. 3 shows the water content of an aqueous solution obtained after step a) of the method according to the invention, when using different numbers of separating stages. As is apparent, the salt concentration of the obtained aqueous solution increases as the number of separating stages increases.

### Example 3

The following table shows the results of a test for using electrocoagulation in order to remove heavy metals from the aqueous solution obtained in step a). These are the analyses of two average samples which were mixed from 11 individual samples in each case.

TABLE 2
Removal of heavy metals by means of electrocoagulation

| | | Concentration | | |
|---|---|---|---|---|
| | | before HM | after HM | Change |
| Component | Unit | precipitation | precipitation | in [%] |
| Chloride | [g/l] | 72.7 | 69.1 | |
| Sulfate | [g/l] | 1.6 | 1.8 | |
| Calcium | [g/l] | 10.1 | 9.19 | |
| Potassium | [g/l] | 59 | 54.1 | |
| Sodium | [g/l] | 2.73 | 2.49 | |
| Antimony | [μg/l] | 0.337 | 0.792 | 135.0 |
| Arsenic | [μg/l] | 0.682 | 0.333 | −51.2 |
| Beryllium | [μg/l] | 1.1 | 1.22 | 10.9 |
| Lead | [μg/l] | 19,800 | 10.8 | −99.9 |
| Cadmium | [μg/l] | 0.153 | 0.163 | 6.5 |
| Chromium | [μg/l] | 250 | 5.11 | −98.0 |
| Cobalt | [μg/l] | 1.69 | 2.61 | 54.4 |
| Copper | [μg/l] | 0.572 | 0.448 | −21.7 |
| Manganese | [μg/l] | 1.26 | 3,060 | from Fe electrode |
| Nickel | [μg/l] | 5.14 | 15 | 192 |
| Mercury | [μg/l] | <0.2 | <0.2 | |
| Tellurium | [μg/l] | 0.121 | 0.16 | 32.2 |
| Thallium | [μg/l] | 319 | 77 | −75.9 |
| Vanadium | [μg/l] | 3.93 | 3.3 | −16.0 |
| Zinc | [μg/l] | 40.1 | 17.2 | −57.1 |
| Tin | [μg/l] | 0.12 | 1.31 | from Fe electrode |

As is clear from the data, in particular the elements lead and chromium were almost completely precipitated. Likewise, the thallium concentration was significantly reduced.

An inconsistent picture resulted for a series of further components, of which, however, only relatively low and therefore non-critical contents were measured also in the starting liquor. This is in part also due to the fact that the individual samples were taken simultaneously before and after sulfate precipitation, although the volume of the neutralization container, reactor and flotation corresponded to a dwell time of several hours. Therefore, the samples taken before and after heavy metal precipitation do not exactly reflect the same operating state of the testing plant, resulting in some degree of uncertainty when comparing these data. The only very small absolute values in the percentage assessment also lead to very large numbers, although the deviations between the measured values are actually in the range of analysis uncertainty.

In particular in the case of manganese, and possibly also in the case of tin, the observed increase when passing through the plant is due to the fact that the iron electrodes (Fe electrodes) of the coagulation reactor were alloyed with approximately 1% manganese and small amounts of tin, which are also found in the pure solution. Such addition of these elements can be prevented by switching to lower alloyed anode materials.

1. A method for treating salt-containing dusts, wherein the method comprises the following steps:
a) forming an aqueous solution by bringing salt-containing dusts into contact with an aqueous phase;
b) removing heavy metals from the aqueous solution; and
c) separating alkali metal chlorides from the aqueous solution,
the bringing of salt-containing dusts into contact with an aqueous phase in step a) is achieved by means of a multi-stage arrangement through which the salt-containing dusts and the aqueous phase pass in opposite directions, and
the ratio of the volume of aqueous phase used to the mass of salt-containing dust used in step a) is in the range of 0.8 l/kg to 1.4 l/kg.

2. The method according to claim 1, wherein for step a) a multi-stage countercurrent cascade is used, which comprises a mixing apparatus in each stage as well as a separating device fed by the outflow from the mixing apparatus.

3. The method according to claim 2, wherein belt filters, centrifuges or filter presses are used as the separating device.

4. The method according to claim 3, wherein for step a) a multi-stage countercurrent cascade of centrifuges is used, and wherein
the salt-containing dusts and the aqueous outflow of the centrifuge belonging to the last stage are fed to the mixing apparatus belonging to the first stage,
the mixing apparatus belonging to the last stage is fed with water as the aqueous phase,
with the exception of the last stage, the solid outflow of a centrifuge is in each case fed to the mixing apparatus belonging to the next stage,
with the exception of the first stage, the aqueous outflow of a centrifuge is in each case fed to the mixing apparatus belonging to the preceding stage, and
the aqueous outflow of the centrifuge belonging to the first stage serves as the starting material for step b).

5. The method according to claim 2, wherein the mixing apparatus is a stirred tank.

6. The method according to claim 1, wherein the multi-stage arrangement in step a) comprises 2 to 5 stages.

7. (canceled)

8. The method according to claim 1, wherein electrocoagulation is used for removing the heavy metals.

9. The method according to claim 1, wherein the alkali metal chlorides are separated in step c) by fractional crystallization.

10. The method according to claim 1, wherein the alkali metal chlorides are at least one selected from the group consisting of sodium chloride (NaCl) and potassium chloride (KCl).

11. The method according to claim 1, wherein the aqueous phase contains at least one auxiliary substance which is selected from inorganic substances.

12. The method according to claim 1, wherein the aqueous solution is evaporated, in the fractional crystallization, to approximately 70% of the volume before step c).

13. The method according to claim 1, wherein the heavy metals are at least one selected from the group consisting of As, Be, Cd, Co, Cr, Cu, Hg, Mn, Ni, Pb, Sb, Sn, Te, Tl and V.

14. The method according to claim 4, wherein part of the aqueous outflow of a centrifuge is returned to the mixing apparatus belonging to the same stage.

15. The method according to claim 1, wherein in the first stage of the multi-stage arrangement an additive is added for precipitating sulfate ions.

16. The method of claim 1, wherein the ratio of the volume of aqueous phase used to the mass of salt-containing dust used in step a) is in the range of 1.0 l/kg to 1.4 l/kg.

17. The method of claim 6, wherein the multi-stage arrangement in step a) comprises 3 or 4 stages.

18. The method of claim 11, wherein the aqueous phase contains ammonium polysulfide and chlorides, nitrates, sulfides and sulfates of the alkali and alkaline earth metals, and organic substances.

19. The method of claim 11, wherein the aqueous phase contains salts of chelating acids such as EDTA.

20. The method of claim 12, wherein the aqueous solution is evaporated, in the fractional crystallization to approximately 50% of the volume before step c).

21. The method of claim 12, wherein the aqueous solution is evaporated, in the fractional crystallization to approximately 30% of the volume before step c).
